(19) United States
(12) Patent Application Publication
(10) Pub. No.: US 2016/0103385 A1
(43) Pub. Date: Apr. 14, 2016

(54) TRIGGER DEVICE

(71) Applicant: YI-FEI ZHANG, MALDEN, MA (US)

(72) Inventor: YI-FEI ZHANG, MALDEN, MA (US)

(21) Appl. No.: 14/510,280

(22) Filed: Oct. 9, 2014

(51) Int. Cl. G03B 15/00

(52) U.S. Cl. CPC G03B 15/00

(57) ABSTRACT

A trigger device is adapted to simultaneously trigger a plurality of camera devices and includes a plurality of switch modules and a control module. The switch modules are coupled correspondingly to the camera devices and that are configured to trigger operation of the camera devices upon receipt of a control signal. The control module is coupled electrically to the switch modules and is operable to transmit simultaneously the control signal to the switch modules.

### FIELD OF THE INVENTION

The invention relates to a trigger device, more particularly to a trigger device adapted to simultaneously trigger a plurality of camera devices.

### BACKGROUND OF THE INVENTION

As shown in FIG. 1, for three-dimensional photography purposes, a conventional trigger device can be utilized to simultaneously trigger operations of a plurality of camera devices 19, each of which has a shutter terminal (S), an auto-focus terminal (AF), and a ground terminal (G). The conventional trigger device includes a shutter switch 11 that is coupled to the shutter terminal (5) of each of the camera devices 19 and that is operable to trigger a shutter function of the camera devices 19, and an auto-focus switch 12 that is coupled to the auto-focus terminal (AF) of each of the camera devices 19 and that is operable to trigger an auto-focus function of the camera devices 19. Since preset voltage differences exist between the shutter terminal (S) and the ground terminal (G) and between the auto-focus terminal (AF) and the ground terminal (5) of each of the camera devices 19, when a user operates either one of the shutter switch 11 and the auto-focus switch 12, electrical connection between the ground terminal (G) and the shutter terminal (S) or the auto-focus terminal (AF) will be made, respectively, so as to trigger the corresponding shutter or auto-focus function of the camera devices 19. However, the electrical connection between the shutter terminal (S) (or the auto-focus terminal (AF) and the ground terminal (G) of each of the camera devices 19 may result in impulse currents, and accumulation of the impulse currents associated with a large number of the camera devices 19 may cause damage to the conventional trigger device or even to the camera devices 19.

### SUMMARY OF THE INVENTION

Therefore, the object of the present invention is to provide a trigger device that may alleviate the aforementioned drawback of the prior art.

Accordingly, a trigger device of the present invention is adapted to simultaneously trigger a plurality of camera devices and includes a plurality of first switch modules and a first control module. The first switch modules are coupled correspondingly to the camera devices and are configured to trigger a first operation of the camera devices upon receipt of a first control signal. The first control module is coupled electrically to the first switch modules and is operable to transmit simultaneously the first control signal to the first switch module.

### BRIEF DESCRIPTION OF THE DRAWINGS

Other features and advantages of the present invention will become apparent in the following detailed description of the exemplary embodiments with reference to the accompanying drawings, of which:

FIG. 1 is a schematic circuit diagram of a conventional trigger device electrically coupled to a plurality of camera devices;

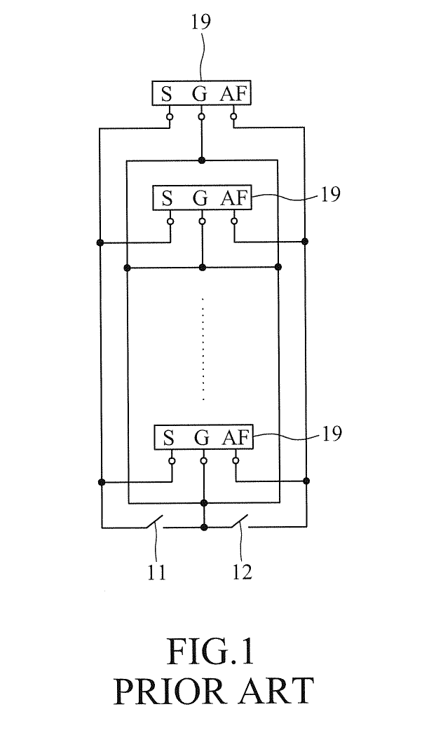

FIG. 2 is a schematic diagram of a first exemplary embodiment of a trigger device according to the present invention;

FIG. 3 is a schematic diagram of the first exemplary embodiment, illustrating a first switch module; and

FIG. 4 is a schematic diagram of a second exemplary embodiment of the trigger device according to the present invention.

### DETAILED DESCRIPTION OF THE EXEMPLARY EMBODIMENTS

Before the present invention is described in greater detail, it should be noted that like elements are denoted by the same reference numerals throughout the disclosure.

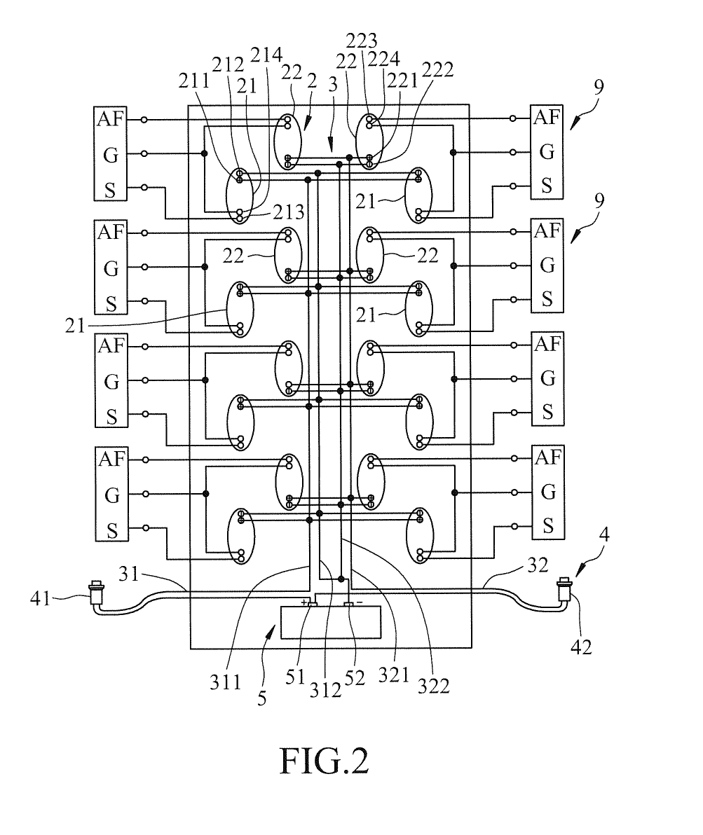

Referring to FIG. 2, the first exemplary embodiment of the trigger device of this invention is adapted to trigger simultaneously a plurality of camera devices 9, each of which has a first control terminal (S), a second control terminal (AF), and a ground terminal (G), and includes a switch unit 2, a control unit 3, an operation switch unit 4, and a power supply unit S. In this example, the first control terminal (S) is a shutter terminal, and the second control terminal (AF) is an auto-focus terminal.

The switch unit 2 includes a plurality of first switch modules 21 and a plurality of second switch modules 22. In this embodiment, the first switch modules 21 are coupled respectively to the camera devices 9, and so are the second switch modules 22.

The first switch modules 21 are configured to trigger a first operation of the camera devices 9 upon receipt of a first control signal. In this embodiment, the first operation is a shutter function. In greater detail, each of the first switch modules 21 has a first trigger terminal 211, a second trigger terminal 212, a first connecting terminal 213, and a second connecting terminal 214. The first and second trigger terminals 211, 212 are configured to receive the first control signal. The first and second connecting terminals 213, 214 are coupled to the first control terminal (S) and the ground terminal (G) of the camera devices 9 correspondingly, such that the first switch modules 21 are operable to make electrical connection between the first control terminal (S) and the ground terminal (G) of the camera devices 9 correspondingly by making electrical connection between the first connecting terminal 213 and the second connecting terminal 214 upon receipt of the first control signal at the first and second trigger terminals 211, 212.

The second switch modules 22 are configured to trigger a second operation of the camera devices 9 upon receipt of a second control signal. In this embodiment, the second operation is an auto-focus function. In greater detail, each of the second switch modules 22 has a first trigger terminal 221, a second trigger terminal 222, a first connecting terminal 223, and a second connecting terminal 224. The first and second trigger terminals 221, 222 of the second switch modules 22 are configured to receive the second control signal. The first and second connecting terminals 223, 224 of the second switch modules 22 are coupled to the second control terminal (AF) and the ground terminal (G) of the camera devices 9 correspondingly, such that the second switch modules 22 are operable to make electrical connection between the second control terminal (AF) and the ground terminal (G) of the camera devices 9 correspondingly by making electrical connection between the first connecting terminal 223 and the second connecting terminal 224 upon receipt of the second control signal at the first and second trigger terminals 221, 222.

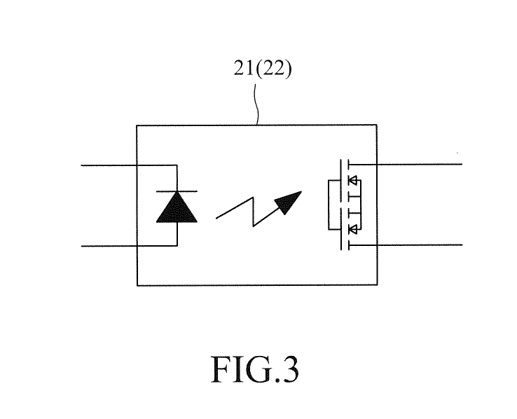

It should be noted that each of the first and second switch modules 21, 22 may be selected from a solid state relay (SSR), a photo coupler (see FIG. 3), and an electromechanical relay. In this embodiment, each of the first and second switch modules 21, 22 is a solid state relay.

The control unit 3 includes a first control module 31 and a second control module 32. The first control module 31 is coupled electrically to the first switch modules 21 and is operable to transmit simultaneously the first control signal to the first switch modules 21. In this embodiment, the first control module 31 includes a first control line 311 that is connected electrically to the first trigger terminals 211 of the first switch modules 21, and a second control line 312 that is electrically connected to the second trigger terminals 212 of the first switch modules 21.

Similarly, the second control module 32 is coupled electrically to the second switch modules 22 and is operable to transmit simultaneously the second control signal to the second switch modules 22. In this embodiment, the second control module 32 includes a first control line 321 that is connected electrically to the first trigger terminals 221 of the second switch modules 22, and a second control line 322 that is electrically connected to the second trigger terminals 222 of the second switch modules 22.

The operation switch unit 4 includes a first operation switch 41 and a second operation switch 42. The first operation switch 41 is coupled to the first control module 31 and is operable to allow transmission of the first control signal to the first control module 31. The second operation switch 42 is coupled to the second control module 32 and is operable to allow transmission of the second control signal to the second control module 32.

The power supply unit 5 is electrically coupled to the first and second control modules 31, 32 via the first and second operation switches 41, 42, respectively, and is operable to provide respectively the first and second control signals to the first and second control modules 31, 32. In this embodiment, the power supply unit 5 has a first power terminal 51 that is electrically connected to the first control line 311 of the first control module 31 via the first operation switch 41 and to the first control line 321 of the second control module 32 via the second operation switch 42, and a second power terminal 52 that is electrically connected to the second control line 312 of the first control module 31 and to the second control line 322 of the second control module 32.

When using the trigger device of the present invention, a user may operate the first operation switch 41 (or the second operation switch 42) so as to trigger the first operation (or the second operation) of the camera devices 9. In greater detail, when the user operates the first operation switch 41 to allow transmission of the first control signal from the power supply unit 5 to the first control module 31, the first control signal is then transmitted simultaneously to the first switch modules 21. Once the first control signal is transmitted to the first and second trigger terminals 211, 212 of the first switch modules 21 by the first and second control lines 311, 312 of the first control module 31, electrical connection between the first and second connecting terminals 213, 214 of the first switch modules 21 is then established, so as to trigger the first operation of the camera devices 9 simultaneously. For instance, when the first operation is a shutter function, once the electrical connection between the first control terminal (S) and the ground terminal (G) of the camera devices 9 is made due to the electrical connection between the first and second control terminals 213, 214 of the first switch modules 21, a preset voltage difference across the first control terminal (S) and the ground terminal (G) of each of the camera devices 9 is thus erased, thereby triggering the shutter function of the camera devices 9.

By incorporating the first and second switch modules 21, 22 into the trigger device of the present invention, various operations of the camera devices 9, such as the shutter function and the auto-focus function, can be triggered using the trigger device of the present invention. Moreover, by virtue of the first and second switch modules 21, 22, the trigger device of the present invention is capable of preventing impulse currents, which are simultaneously generated due to establishment of the electrical connection between the first control terminal (S) (or the second control terminal (AF)) and the ground terminal (G) of each of the camera devices 9, from accumulating at the first control module 31 (or the second control module 32), so that the aforementioned problem of the prior art can be effectively alleviated, and that the number of the camera devices 9 to be connected to the trigger device of the present invention may be increased as desired.

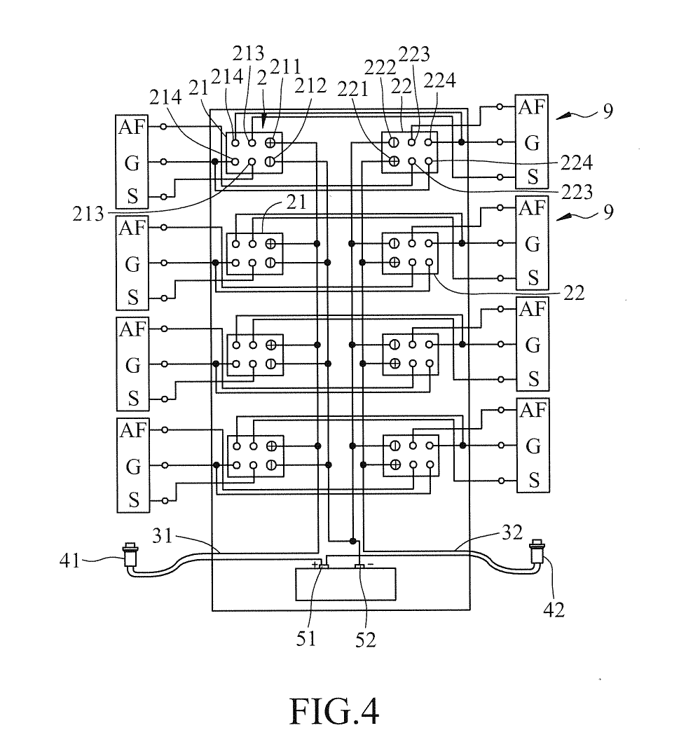

Referring to FIG. 4, the second exemplary embodiment of the trigger device according to the present invention is shown to be similar to that of the first exemplary embodiment. The difference between the first and second exemplary embodiments resides in that each of the first and second switch modules 21, 22 is an electromechanical relay (EMR). In addition, each of the first (or second) switch modules 21 (or 22) of the second exemplary embodiment has two sets of the first and second connecting terminals 213, 214 (or 223, 224), and each set is coupled to a respective one of the camera devices 9.

While the present invention has been described in connection with what are considered the most practical embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A trigger device adapted to simultaneously trigger a plurality of camera devices, said trigger device comprising:
a plurality of first switch modules that are coupled correspondingly to the camera devices and that are configured to trigger a first operation of the camera devices upon receipt of a first control signal; and
a first control module that is coupled electrically to said first switch modules and that is operable to transmit simultaneously the first control signal to said first switch modules.

2. The trigger device according to claim 1, further comprising a first operation switch that is coupled to said first control module and that is operable to allow transmission of the first control signal to said first control module.

3. The trigger device according to claim 2, each of the camera devices having a control terminal and a ground terminal, wherein said first switch modules are coupled to the control terminal and the ground terminal of the camera devices correspondingly and are operable to make electrical connection between the control terminal and the ground terminal of the camera devices correspondingly upon receipt of the first control signal.

4. The trigger device according to claim 3, wherein:
each of said first switch modules includes a first trigger terminal and a second trigger terminal;
said first control module includes a first control line that is connected electrically to said first trigger terminal of each of said first switch modules, and a second control line that is connected electrically to said second trigger terminal of each of said first switch modules; and
said trigger device further comprises a first signal terminal and a second signal terminal that are configured to receive the first control signal and that are connected electrically and respectively to said first and second control lines via said first operation switch.

5. The trigger device according to claim 1, wherein each of said first switch modules is selected from a photo coupler, a solid state relay, and an electromechanical relay.

6. The trigger device according to claim 1, further comprising:
a plurality of second switch modules that are coupled correspondingly to the camera devices and that are configured to trigger a second operation of the camera devices upon receipt of a second control signal; and
a second control module that is coupled electrically to said second switch modules and that is operable to transmit the second control signal simultaneously to said second switch modules.

7. The trigger device according to claim 6, further comprising a second operation switch that is coupled to said second control module and that is operable to allow transmission of the second control signal to said second control module.

8. The trigger device according to claim 7, each of the camera devices having a control terminal and a ground terminal, wherein said second switch modules are coupled to the control terminal and the ground terminal of the camera devices correspondingly and are operable to make electrical connection between the control terminal and the ground terminal of the camera devices correspondingly upon receipt of the second control signal.

9. The trigger device according to claim 8, wherein:
each of said second switch modules includes a first trigger terminal and a second trigger terminal;
said second control module includes a first control line that is connected electrically to said first trigger terminal of each of said second switch modules, and a second control line that is connected electrically to said second trigger terminal of each of said second switch modules; and
said trigger device further comprises a first signal terminal and a second signal terminal that are configured to receive the second control signal and that are connected electrically and respectively to said first and second control lines via said second operation switch.

10. The trigger device according to claim 6, wherein each of said second switch modules is selected from a photo coupler, a solid state relay, and an electromechanical relay.

11. The trigger device according to claim 1, wherein the first operation of the camera devices is one of a shutter function and an auto-focus function.

12. The trigger device according to claim 6, wherein the first operation of the camera devices is a shutter function, and the second operation of the camera devices is an auto-focus function.
